(19) United States
(12) Patent Application Publication
(10) Pub. No.: US 2005/0028160 A1
(43) Pub. Date: Feb. 3, 2005

(54) Adaptive scheduler for anytime tasks

(75) Inventors: Darren D, Cofer, Minnetonka, MN (US); John J. Shackleton, Blaine, MN (US); Mukul Agrawal, Plymouth, MN (US); Nigel Birch, Minneapolis, MN (US)

Correspondence Address: Honeywell International Inc., 101 Columbia Road, Law Dept. AB2, Morristown, NJ, 07962, US

(73) Assignee: Honeywell International Inc.

(21) Appl. No.: 10/903,144

(22) Filed: Jul. 30, 2004

Related U.S. Application Data
(60) Provisional application No. 60/492,164, filed on Aug. 1, 2003.

(51) Int. Cl. G06F 9/46

(52) U.S. Cl. 718/100

(57) ABSTRACT

Scheduling a set of anytime tasks includes assigning a percentage of at least one resource to each of the set of anytime tasks and allowing each of the set of anytime tasks to use the at least one resource in accordance with the respective assigned fraction. The percentage of the at least one resource assigned to each of the set of anytime tasks is subsequently adapted.

### CROSS REFERENCE TO RELATED APPLICATIONS

This application is related to and claims the benefit of the filing date of U.S. Provisional Application No. 60/492,164, filed on Aug. 1, 2003, which is incorporated herein by reference.

### TECHNICAL FIELD

The following description relates to control algorithms in general and to an adaptive scheduler for anytime tasks in particular.

### BACKGROUND

Software that is executed on one or more programmable processors is typically divided into a set of tasks. A scheduler is used to allocate to each of the tasks a percentage of the computing resources available during a given amount of time. This amount of time is also referred to here as a “scheduling period” though is to be understood that successive scheduling periods are not necessarily the same length nor periodic. Examples of such computing resources (also referred to here as “scheduled resources”) include execution time on a programmable processor, storage, network bandwidth, and electrical power.

One type of scheduling technique allocates each task a fixed percentage of each scheduled resource for each scheduling period. This type of scheduling technique is typically designed for use with tasks that are designed to use a fixed or bounded amount of each scheduled resource. Examples of such tasks include “periodic tasks” that execute for a fixed amount of time on a periodic basis and “aperiodic tasks” (also referred to as “asynchronous tasks”) that are executed a single time in response to some event. This type of scheduling technique is also referred to here as a “periodic scheduling technique” or “periodic scheduling.”

Another type of task is designed to make use of up to one-hundred percent of one or more scheduled resources (typically, processor time) that are available during any given scheduling period. Such tasks typically are designed to be executed at any time in order to make use of such available scheduled resources. These tasks are also referred to here as “anytime tasks.” The performance of an anytime task typically increases when the task is provided with an increased amount of scheduled resources to use.

Typically, anytime tasks are scheduled using periodic scheduling techniques (for example, using rate monotonic scheduling (RMS)) with the anytime task executing at a low priority and an infrequent rate. Often, such anytime tasks, though important to achieve good system performance, are not critical to overall system performance, and consequently are relegated to the level of background tasks when typical periodic scheduling techniques are used. Periodic scheduling techniques, however, typically do not include the flexibility to adapt the amount of resources assigned to such anytime tasks in order to increase or decrease the performance of the anytime tasks based on the state of the system or the environment in which the system operates. This can result in suboptimal use of the scheduled resources and a reduction in overall system performance. Periodic scheduling techniques also do not typically provide a mechanism to arbitrate between anytime tasks competing for resources.

### SUMMARY

In one embodiment, a method of scheduling a set of anytime tasks includes assigning a percentage of at least one resource to each of the set of anytime tasks and allowing each of the set of anytime tasks to use the at least one resource in accordance with the respective assigned fraction. The method further includes adapting the percentage of the at least one resource assigned to each of the set of anytime tasks.

In another embodiment, a method schedules a set of anytime tasks for execution on a programmable processor. The method includes executing a policy task on the programmable processor that adapts a percentage of a resource allocated to each of the set of anytime tasks. The method further includes executing each of the set of anytime tasks on the programmable processor in accordance with the percentage of the resource allocated to each of the set of anytime tasks.

In another embodiment, software comprises a plurality of instructions embodied on a processor-accessible medium. The instructions, when executed by at least one programmable processor, cause the programmable processor to execute a policy task that adapts a percentage of a resource allocated to each of a set of anytime tasks and execute an anytime scheduler that schedules the execution of a set of anytime tasks in accordance with the percentage of the resource allocated to each of the set of anytime tasks.

In another embodiment, a system includes a programmable processor and software embodied on a medium accessible by the programmable processor. The software comprises program instructions operable to cause the programmable processor to execute a policy task that adapts a percentage of a resource allocated to each of a set of anytime tasks and execute an anytime scheduler that schedules the execution of a set of anytime tasks in accordance with the percentage of the resource allocated to each of the set of anytime tasks.

In another embodiment, an apparatus includes means for executing a policy task on a programmable processor. The policy task adapts a percentage of a resource allocated to each of a set of anytime tasks. The apparatus further includes means for executing each of the set of anytime tasks on the programmable processor in accordance with the percentage of the resource allocated to each of the set of anytime tasks.

### DRAWINGS

FIG. 1 is a block diagram of one embodiment of an anytime scheduling framework for scheduling anytime tasks.

FIG. 2 is a flow diagram of an exemplary embodiment of a method of determining the percentage of each scheduled resource that is allocated to each task.

FIG. 3 is a flow diagram of an exemplary embodiment of a method of determining the percentage of each scheduled resource that is allocated to each task.

FIG. 4 is a flow diagram of an exemplary embodiment of a method of scheduling.

FIG. 5 is a block diagram of one embodiment of such a system.

FIG. 6 is a block diagram of one embodiment of an avionics system.

### DETAILED DESCRIPTION

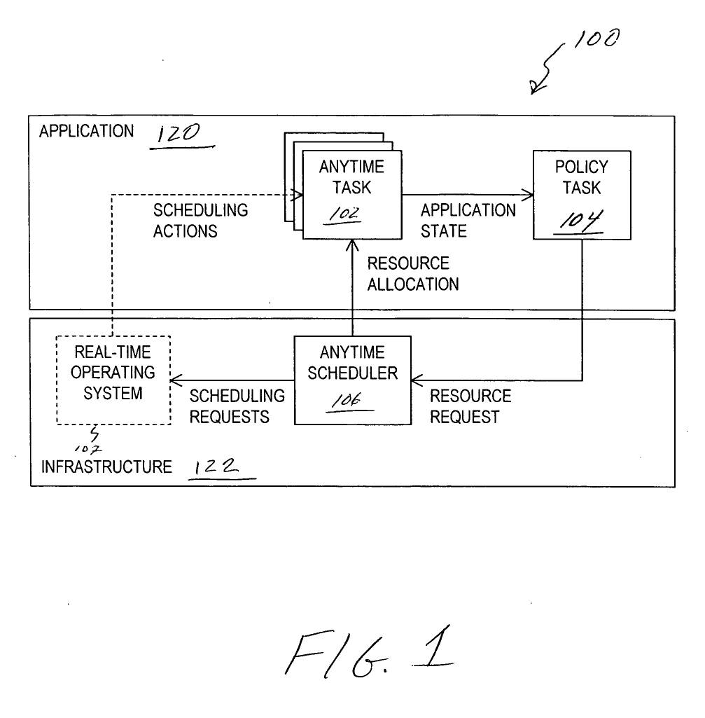

FIG. 1 is a block diagram of one embodiment of an anytime scheduling framework 100 (also referred to here as the “anytime framework”) for scheduling anytime tasks. In one embodiment, the anytime framework 100 is implemented in software that is executed by at least one programmable processor (for example, by at least one microprocessor). In such an embodiment, the software comprises program instructions that are embodied in or on a medium from which the program instructions are read by the programmable processor for execution thereby.

The anytime framework 100 is operable to schedule a set of anytime tasks 102. Although three anytime tasks are shown in FIG. 1, it is to be understood the actual number and types of anytime tasks 102 that are scheduled by the anytime framework 100 can vary depending on the nature of each particular embodiment. In one embodiment, a fixed number of anytime tasks 102 are executed each time the system in which the server 100 is implemented is operated. The system in which the anytime framework 100 is implemented is also referred to here as just the “system.” In other embodiments, the number and/or types of anytime tasks 102 that are executed varies, for example, with the state of the system and/or on user input. For example, in one such embodiment, a particular anytime task 102 is executed only under certain conditions (for example, under certain environmental conditions, operation modes, or when requested by a user of the system). In one implementation of such an embodiment, the system includes an admission mechanism (not shown) that determines if one or more particular anytime tasks 102 should be admitted for scheduling by the anytime scheduler 106. For example, in one such implementation, such admission functionality is incorporated into the anytime scheduler 106. In another implementation, such admission functionality is implemented by a part of the system other than the anytime scheduler 106.

An anytime task 102 is designed to be ready to be executed at any time and to make use of up to one-hundred percent of one or more scheduled resources (typically, processor time) that are available during any given scheduling period in which anytime tasks are executed (also referred to here as an “anytime scheduling period”). Since each of the anytime tasks 102 has been designed to use up to one-hundred percent of the available scheduled resources, the framework 100 must mediate the competing requests of the anytime tasks 102 to use the scheduled resources. In one embodiment, each anytime task 102 is implemented as a separate thread, the execution of which can be stopped (that is, preempted) or started or restarted (that is, resumed) by the anytime scheduler 106 (described below). From the perspective of each anytime task 102, execution is continuous and the actions of the anytime scheduler 106 are transparent.

In one embodiment, the anytime tasks 102 are implemented using algorithms that include one or more of the following properties. In one embodiment, the algorithms used to implement one or more of the anytime tasks 102 are designed for continual execution. That is, such algorithms are continually executing in the sense, as noted above, that such algorithms are always “ready-to-run.” Such algorithms are designed to use up to one-hundred percent of the available scheduled resources (for example, processor time) in order to produce improved results. The performance of such algorithms typically increases when the algorithms are provided with an increased amount of scheduled resources to use. For example, in one implementation, one or more of the anytime tasks 102 are implemented using an iterative algorithm (for example, comprising an infinite loop) that provides increased performance (for example, increased resolution or accuracy) with the execution of each iteration of the algorithm. Such algorithms continually refine the results produced by each iteration (sometimes referred to as “imprecise computation”) or each iteration produces a new output based on an “infinite” set of time-varying inputs. In other implementations, continual execution is implemented in other ways.

In one embodiment, the algorithms used to implement one or more of the anytime tasks 102 have a relatively large computation time and deadlines. In one implementation of such an embodiment, where an iterative algorithm is used, each iteration of the algorithm that is needed to produce or refine a result is typically (though not necessarily) an order of magnitude larger than the base system clock rate of the system. For example, in one such implementation where the anytime task 102 is used to determine a path or route from point A to point B, each iteration of a path-planning algorithm used by such an anytime task 102 takes up to one second to generate a result from one set of inputs, whereas the underlying base system clock rate is at 80 Hertz (Hz).

In one embodiment, the algorithms used to implement one or more of the anytime tasks 102 are able to vary the amount of execution time used by the algorithms in order to produce a new or refined result. In one implementation of such an embodiment, the algorithm used by an anytime task 102 varies the execution time of the algorithm based on one or more attributes of the data being processed (for example, the density and motion in an image captured by a vision sensor) and/or the amount of one or more computational resources (including but not limited to one or more scheduled resources) available for use by the algorithm (for example, by parameterizing the processing performed by the algorithm to allow the algorithm to vary the execution time based on the resources available and the deadline imposed to produce a new or refined result).

In one embodiment, the algorithms used to implement one or more of the anytime tasks 102 are able to adapt the processing performed by the algorithms based on a number of different factors and/or application-specific needs or objectives. For example, in an embodiment where an anytime task 102 is used to model the current weather, the algorithm used to implement such an anytime task 102 is able to produce a result using one or more high-fidelity simulations or using one or more relatively “crude” computations. In such an embodiment, the algorithm may choose one of the crude computations to produce a result on an urgent basis. When the algorithm has more time to produce a result, one of the high-fidelity simulations can be used to produce a result.

The anytime framework 100 comprises a policy task 104. The policy task 104 determines the percentage of each scheduled resource that is allocated to each anytime task 102. Examples of factors that are used by the policy task 104, in some embodiments, to make this determination include the criticality or deadlines of each of the anytime tasks 102 (or other tasks) that are scheduled by the anytime scheduler 106 and/or the particular mission scenario of the system. Allocation of the appropriate percentage or weight to each task is typically a control activity that is used to optimize, for example, overall system performance.

In one embodiment, each anytime task 102 that is currently scheduled by the anytime scheduler 106 communicates to the policy task 104, from time to time, information indicative of the amount of one or more scheduled resources that that anytime task 102 needs or wants to use during execution. The policy task 104, in such an embodiment, uses this information in determining how much of each scheduled resource to allocate to each anytime task 102. For example, in one implementation of such an embodiment, the information that is communicated to the policy task 104 comprises a request that specifies a minimum amount of each scheduled resource that allows the sending anytime task 102 to achieve a minimum quality of service (QoS) level. In other implementations, each such request also specifies a maximum amount of each scheduled resource that allows the sending anytime task 102 to achieve a maximum QoS level.

In one embodiment, the policy task 104, in addition to determining the percentage of each scheduled resource that is allocated to each anytime task 102, also determines the percentage of each scheduled resource that is allocated to the policy task 104 itself. In another embodiment, the execution of the policy task 104 and/or allocation of computing resources for use by the policy task 104 is controlled or determined by a scheduling mechanism other than the anytime scheduler 106 (for example, by a separate real-time scheduler or separate periodic task scheduler).

The policy task 104 performs the initial allocation of each scheduled resource and, thereafter, adapts the percentage of each scheduled resource that is allocated to each anytime task 102 (and the policy task 104 if appropriate). The updated resource allocation request is communicated to an anytime scheduler 106. As described below, the anytime scheduler 106 uses the updated resource allocation for scheduling and executing (and/or otherwise allowing the use of the scheduled resources by) the anytime tasks 102 (and the policy task 104 if appropriate).

In one embodiment, the policy task 104 determines the percentage of each scheduled resource that should be assigned to each anytime task 102 (and to the policy task 104 if appropriate) by first calculating a weight for each such task. For each scheduled resource, after all the weights have been calculated for all the tasks to be scheduled, the policy task 104 normalizes each calculated weight by dividing it by the sum of all the calculated weights for that scheduled resource. In other embodiments, the policy task 104 determines the percentage of each scheduled resource that should be assigned to each anytime task 102 (and to the policy task 104 if appropriate) in other ways.

In one embodiment where the scheduled resource comprises processor time, the resolution of the weight or percentage assigned to each anytime task 102 is dependent upon the time granularity of the system in which the anytime framework 100 is implemented. Typically, this is dependant on the particular operating system that is used. For example, in one implementation that is implemented using an operating system from the MICROSOFT WINDOWS family of operating systems, the underlying software timers typically pulse at 10 milliseconds. Thus, in such an implementation, the weight or percentage of processor time that is assigned to each of the tasks is defined in increments that are roughly ten percent of the typical anytime scheduling period. In other implementations where the underlying software timers are faster (for example, using an embedded operating system such as the WIND RIVER VXWORKS operating system where the software timers pulse at 100 microseconds), the weights or percentages can be defined in much finer (that is smaller) increments.

In one embodiment, the anytime scheduler 106 communicates scheduling requests to a real-time scheduler or operating system to indicate when an anytime task 106 should be executed by such real-time scheduler or operating system. For example in the embodiment shown in FIG. 1, the anytime tasks 102, the policy task 104, and the anytime scheduler 106 interact with a real-time operating system (RTOS) 107 for scheduling (though, in such an embodiment, the RTOS 107 is not part of the anytime scheduling framework 100, which comprises the set of anytime tasks 102, the policy task 104, and the anytime scheduler 106). In other embodiments, the anytime scheduler 106 directly controls task scheduling and execution.

In the embodiment shown in FIG. 1, the anytime tasks 102 communicate application state information to the policy task 104 indicating the current condition, needs, or operating scenario of the anytime tasks 102. The policy task 104, in such an embodiment, may use this information to compute an optimal allocation of resources among the anytime tasks 102, which is then communicated as a request to the anytime scheduler 106. The anytime scheduler 106 enacts the resource allocation requested by the policy task 104, determining when each anytime task 102 is executed and for how long. In the embodiment shown in FIG. 1, the anytime tasks 102 may request to receive from the anytime scheduler 106 their current resource allocation and adapt their computational behavior accordingly.

In the embodiment shown in FIG. 1, the anytime tasks 102 and the policy task 104 comprise a part of the application-level software 120 executed by the system and are defined by the system designer. The anytime scheduler 106 (and the real-time operating system 107 in the embodiment shown in FIG. 1) are implemented as a part of the system infrastructure 122 (for example, as a part of the operating system or other system control software) and are not modified by the system designer. In other words, the system designer who implements the anytime tasks 102 would, in such an embodiment, also implement a policy task 104 that allocates the amount of scheduled resources assigned to each of the anytime tasks 102 (for example, the initial allocation and subsequent adaptation). This enables the policy task 104 to make use of knowledge about the particular application domain of the anytime tasks 102 in making the trade-offs that govern the percentage of each scheduled resource that is allocated to each anytime task 102.

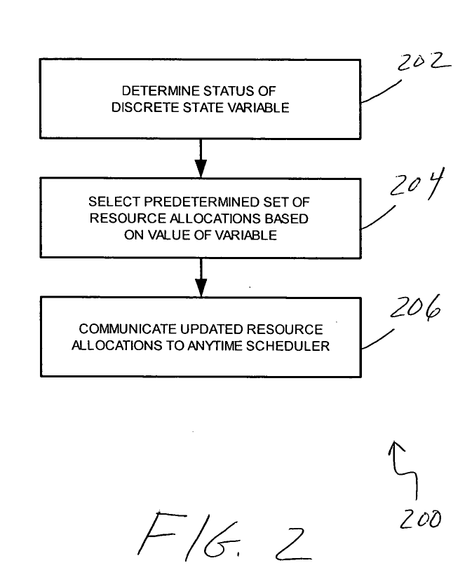

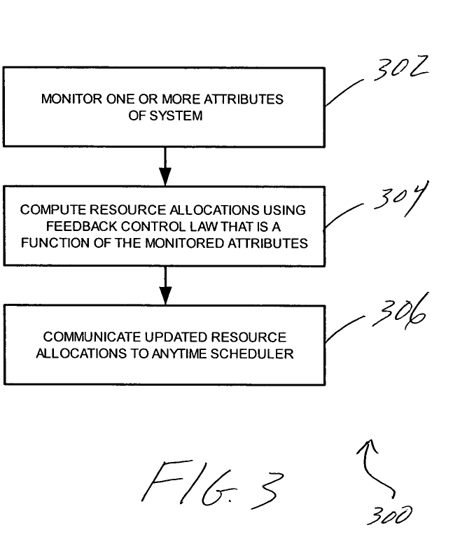

Exemplary embodiments of the processing performed by the policy task 104 are shown in FIGS. 2 and 3. It is to be understood that, in other embodiments, the policy task 104 is implemented in other ways. FIG. 2 is a flow diagram of an exemplary embodiment of a method 200 of determining the percentage of each scheduled resource that is allocated to each task. The particular processing shown in FIG. 2 is performed each time the policy task 104 is executed. In one implementation of the embodiment shown in FIG. 2, the policy task 104 is implemented as a periodic task with a fixed period and time budget. In the embodiment shown in FIG. 2, the policy task 104 determines the current status of a discrete state variable (or other attribute of the system) (block 202). For example, in one implementation where the system supports multiple modes of operation, the policy task 104 determines the mode in which the system is currently operating (for example, by accessing a register or other memory location in which the current mode is stored).

The policy task 104, in the embodiment shown in FIG. 2, selects a predetermined set of resource allocations based on the value of the state variable (block 204). For example, in one implementation where the system supports multiple modes of operation, each mode of operation has a particular set of resource allocations associated with that mode. Each resource allocation specifies, for each task, the percentage of each scheduled resource that is assigned to that task.

The policy task 104, in the embodiment shown in FIG. 2, communicates the updated resource allocation to the anytime scheduler 106 (block 206). The anytime scheduler 106 stores the updated resource allocation in an appropriate data structure for subsequent access by the anytime scheduler 106.

FIG. 3 is a flow diagram of an exemplary embodiment of a method 300 of determining the percentage of each scheduled resource that is allocated to each task. The particular processing shown in FIG. 3 is performed one or more times each time the policy task 104 is allowed to execute. In one implementation of the embodiment shown in FIG. 3, the policy task 104 is implemented as an anytime task that is scheduled and executed by the anytime scheduler 106.

In the embodiment shown in FIG. 3, the policy task 104 is a control or optimization task. The policy task 104, in such an embodiment, monitors one or more attributes of the system (block 302). In one implementation, the policy task 104 monitors one or attributes of the overall performance of the system and/or one or more attributes related to the anytime tasks 102 or the policy task 104 itself. Then, the policy task 104 computes the current resource allocations using a continuous-valued feedback control law that is a function of the monitored attributes (block 304). For example, in one implementation, the control law, each time it is computed by the policy task 104, adjusts the amount of each scheduled resource assigned to each anytime task in order to improve overall system performance and to meet the minimum QoS requirements of the various anytime tasks 102.

The policy task 104, in the embodiment shown in FIG. 3, communicates the updated resource allocation to the anytime scheduler 106 (block 306). The anytime scheduler 106 stores the updated resource allocation in an appropriate data structure for subsequent access by the anytime scheduler 106.

The anytime framework 100 (shown in FIG. 1) also comprises an anytime scheduler 106. The anytime scheduler 106 determines how much of each scheduled resource each anytime task 102 uses during each anytime scheduling period. The anytime scheduler 106 also determines when each anytime task 102 is executed (and/or is otherwise allowed to use the scheduled resources) during each anytime scheduling period. In the embodiment shown in FIG. 1, the anytime scheduler 106 also makes these determinations for the policy task 104. In one embodiment, the anytime scheduler 106 is invoked periodically at a defined rate. In one implementation of such an embodiment, invocation of the anytime scheduler 106 is triggered by a hardware timer or by a separate scheduling mechanism (for example, by a separate real-time scheduler).

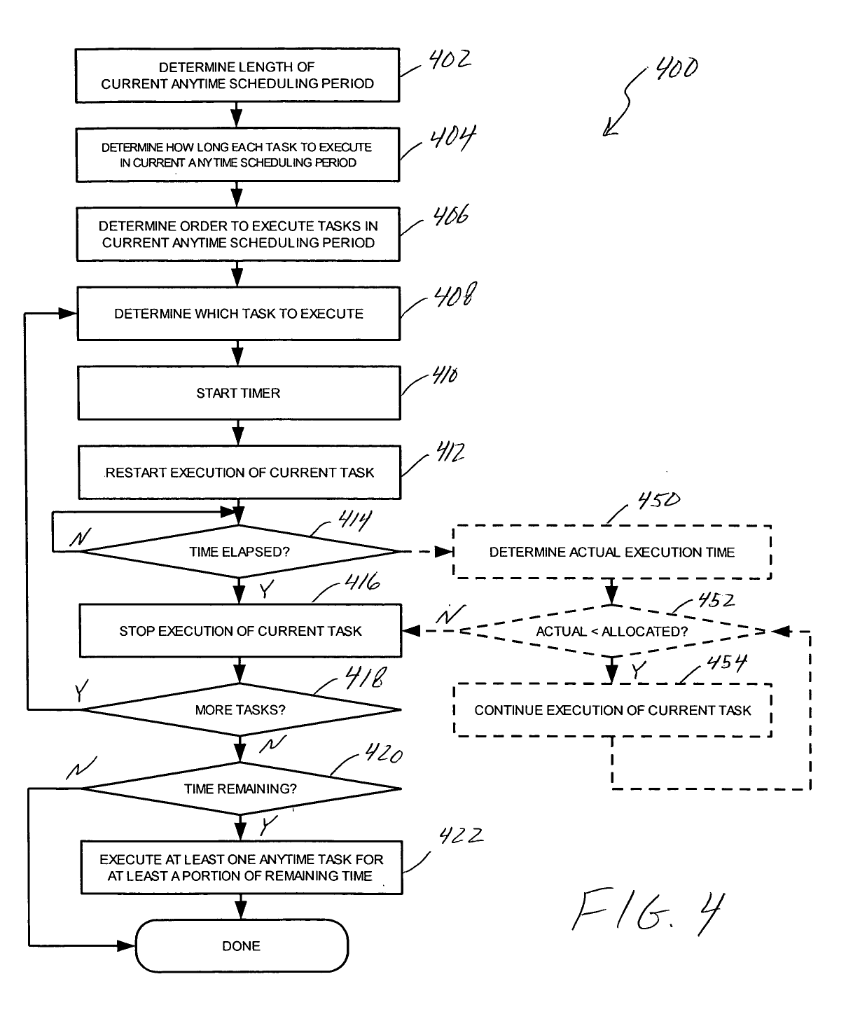

An exemplary embodiment of the processing performed by the anytime scheduler 106 is shown in FIG. 4. FIG. 4 is a flow diagram of an exemplary embodiment of a method 400 of scheduling. The particular processing shown in FIG. 4 is performed for each anytime scheduling period. In the particular embodiment shown in FIG. 4, the scheduled resource comprises processing time. The anytime scheduler 106 determines the length of the current anytime scheduling period (block 402). In one implementation, the length of each anytime scheduling period is fixed. In another implementation where the anytime scheduler 106 is invoked by a separate scheduling mechanism, the anytime scheduler 106 is provided with the length of the current anytime scheduling period by the scheduling mechanism (for example, by a real-time scheduler). In another implementation, the anytime scheduler 106 retrieves the length of the current anytime scheduling period from the underlying operating system that executes the anytime framework 100. In other implementations, the length of the current anytime scheduling period is determined in other ways.

The anytime scheduler 106 also determines how long each of the anytime tasks 102 and the policy task 104 will be executed (and/or otherwise allowed to use the scheduled resources) during the current anytime scheduling period (block 404). How long each of the anytime tasks 102 and the policy task 104 will be executed during the current anytime scheduling period is computed as a function of the current resource allocations output by the policy task 104. The anytime scheduler 106, in making such a determination, retrieves the current resource allocation from the data structure in which it is stored. In one implementation, the determination as to how long each of the anytime tasks 102 and the policy task 104 will be executed during the current anytime scheduling period is made by multiplying the percentage allocation for each task with the length of the current anytime scheduling period.

The anytime scheduler 106 also determines the order in which each of the anytime tasks 102 and the policy task 104 are executed (and/or are otherwise allowed to use the scheduled resources) during the current anytime scheduling period (block 406). In one implementation, an order in which to execute each of the tasks is generated by the policy task 104 when the policy task 104 is executed. In such an implementation, the order in which the tasks are to be executed is stored, along with the resource allocations, in an appropriate data structure and the anytime scheduler 106 determines the order in which to execute the tasks by retrieving the order stored in the data structure. In another implementation, the anytime scheduler 106 generates or calculates the order in which the tasks are executed in other ways.

The anytime scheduler 106 determines which task (also referred to here as the “current task”) to execute or otherwise allow to use the scheduled resources (block 408), starts a timer (block 410), and restarts execution of (and/or otherwise allows use of the scheduled resources by) the current task (block 412). In this embodiment, the current task is either an anytime task 102 or the policy task 104. The timer, in one implementation, is implemented as a count-down timer that is initialized with a value that corresponds to the amount of time the current task is allocated during the current anytime scheduling period. In one implementation where each task is implemented as a separate thread, the anytime scheduler 106 restarts execution of the current task by explicitly resuming execution of the thread that implements the current task. In another implementation, the execution of the current task is restarted by adjusting the priority of the current task (for example, by adjusting the priority of the thread that implements the current task). In other implementations, the current task is restarted in other ways. In one implementation, at least one of the anytime tasks 102, when it is executed by the anytime scheduler 102, changes or adapts the way in which that anytime task 102 executes based on the amount of time allocated to that task 102 during the current anytime scheduling period.

The anytime scheduler 106 determines when the timer indicates that the amount of time allocated to the current task during the current anytime scheduling period has elapsed since restarting the task (checked in block 414). When the timer indicates that the amount of time allocated to the current task during the current anytime scheduling period has elapsed since restarting the task, the anytime scheduler 106 stops execution of (and/or other use of the scheduled resources by) the current task (block 416). In one implementation where each task is implemented as a separate thread, the thread that implements the current task is explicitly suspended by the anytime scheduler 106 in order to stop execution of the current task. In another implementation, the execution of the current task is stopped by adjusting the priority of the current task (for example, by adjusting the priority of the thread that implements the current task). In other implementations, the current task is stopped in other ways.

If there are more tasks to execute (and/or otherwise use the scheduled resources) during the current anytime scheduling cycle (checked in block 418), the anytime scheduler 106 determines which task to execute next, starts the timer and restarts execution of the next task (looping back to block 408). This processing is performed for each task that is scheduled to execute during the current anytime scheduling period.

In the embodiment shown in FIG. 4, if, after all the tasks have been executed by the anytime scheduler 106, additional time remains in the current anytime scheduling period (checked in block 420), the anytime scheduler 106 allows at least one anytime task 102 to execute (and/or otherwise use the scheduled resources) for at least a portion of the remaining time in the current anytime scheduling period (block 422). In one implementation, each of the anytime task 102 scheduled by the anytime scheduler 106 has an associated flag (or other attribute) that indicates whether that anytime task 102 should be executed when additional time remains in the current anytime scheduling period. In one such implementation, the policy task 104 dynamically sets or clears this flag (or otherwise adapts the relevant attribute) as part of the processing performed by the policy task 104. For example, in some circumstances, it may not be desirable for a particular anytime task 102 to be executed during such additional time. In one implementation, the anytime scheduler 106 allocates such additional time based on the relative percentages assigned to each anytime task 102 that has the flag set.

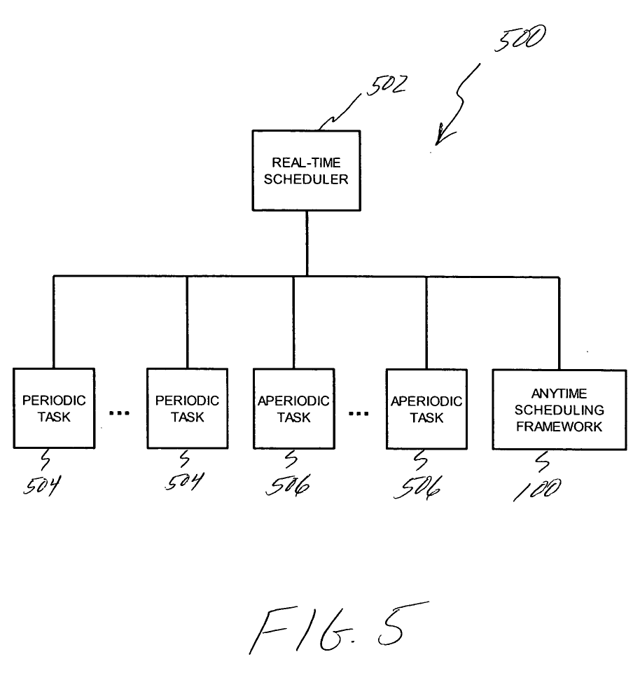

In one embodiment of the anytime framework 100, the anytime framework 100 coexists with other real-time tasks that include, for example, periodic tasks that have hard real-time deadlines. In addition, in such an embodiment, interrupt events may need to be serviced from time-to-time. FIG. 5 is a block diagram of one embodiment of such a system 500. The system 500 comprises a real-time scheduler 502 that schedules the execution of one or more periodic tasks 504, one or more aperiodic tasks 506 (for example, one or more interrupt service routines), and the anytime framework 100. The real-time scheduler 502 executes the anytime framework 100 for each of the anytime scheduling periods.

In one implementation of the embodiment of system 500 shown in FIG. 5, the anytime framework 100, including the anytime scheduler 106 and all the tasks 102 and 104 scheduled thereby, are not allowed to be preempted. For example, in one such implementation, the various components of the anytime framework 100 (the anytime scheduler 106 and the tasks 102 and 104) are assigned execution priorities that are higher than any other tasks in the system 500 for the duration of each anytime scheduling period. To prevent undesirable delay or jitter in other periodic real-time tasks or in servicing interrupt events, the anytime scheduler 106, in one implementation, is invoked at the highest periodic rate supported by the real-time scheduler 502. Since no anytime task will be executed for longer than the period associated with the highest periodic rate in such an implementation, blocking of the periodic tasks 504 will typically be limited and the periodic tasks 504 will typically still be able to meet their periodic deadlines.

In another implementation of such an embodiment, the real-time scheduler 502 is able to preempt the execution of the anytime framework 100 (including the anytime scheduler 106 and the tasks 102 and 104). As result, in such an implementation, during an anytime scheduling period, it may be the case that, when the amount of time allocated to the current anytime task has elapsed since restarting the task, the current anytime task may not have been executed for the entire amount of time allocated to that anytime task (for example, because that anytime task was preempted by the real-time scheduler 502 to allow a higher priority periodic task 502 to execute or to service an interrupt event). The amount of time that the current task was actually executed (and/or otherwise allowed to use the scheduled resources) between the time the current task was restarted and when the timer indicated that the amount of time allocated to the current task had elapsed is also referred to here as the “actual execution time.” A modification to the embodiment of method 400 shown in FIG. 4 that supports such an implementation is shown in FIG. 4 using dashed lines.

In the modified embodiment shown in FIG. 4, the anytime scheduler 106, when the timer indicates that the amount of time allocated to the current task during the current anytime scheduling period has elapsed since restarting the task (checked in block 414), instead of transitioning directly to block 416, the actual execution time for the current task is determined (in block 450). In one such implementation, the underlying operating system of the system 500 provides the actual execution time for the current task to the anytime scheduler 106.

If the actual execution time for the current task is less than the amount of time allocated to the current task for the current anytime scheduling period (checked in block 452), the anytime scheduler 106 allows the current task to execute (and/or otherwise use the scheduled resources) until the actual execution time for the current task is equal to the amount of time allocated to the current task for the current anytime scheduling cycle (block 454 and looping back to block 452). When the actual execution time is equal to the amount of time allocated to the current task for the current anytime scheduling period, the execution of the current task is stopped (block 416) and any remaining tasks are executed as described above in connection with FIG. 4.

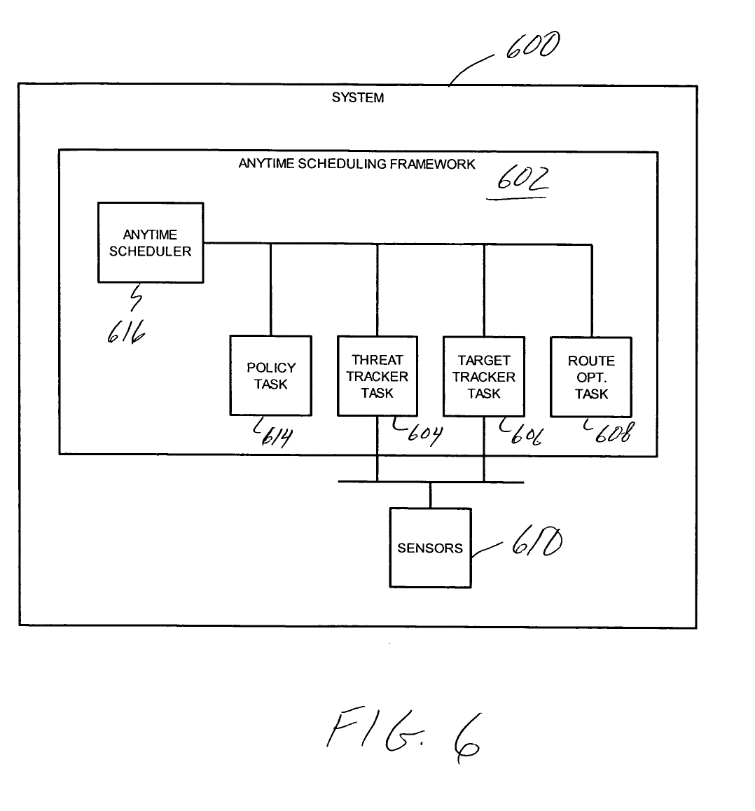

FIG. 6 is a block diagram of one embodiment of an avionics system 600. The embodiment of system 600 shown in FIG. 6 comprises an anytime framework 602 that schedules and executes one or more anytime tasks. The anytime framework 602 shown in FIG. 6 is an embodiment of the anytime framework 100 of FIG. 1. In the embodiment shown in FIG. 6, system 600 is used to control an aircraft. The anytime scheduler 602 schedules and executes three anytime tasks in the example shown in FIG. 6: a threat tracker task 604, a target tracker task 606, and a route optimization task 608. The threat tracker task 604 and the target tracker task 606 receive and process information about threats and targets, respectively, that is generated by one or more sensors 610. The results of the threat and target processing performed by the threat tracker task 604 and the target tracker task 606, respectively, are communicated to the route optimization task 608. The route optimization task 608 then calculates an optimal route to avoid any threats and to hit any targets.

The anytime framework 602 includes a policy task 614 that is an embodiment of the policy task 104 of FIG. 1. The policy task 614 allocates each of the tasks 604, 606, and 608 a percentage of any scheduled resources (for example, processor time) used by the anytime tasks 604, 606, and 608. In one implementation, the policy task 614 allocates the scheduled resources based on resource requests sent to the policy task 614 by the anytime tasks 604, 606, and 608 and target and threat information generated by tasks 604 and 606, respectively.

The anytime framework 602 includes an anytime scheduler 616 that is an embodiment of the anytime scheduler 106 of FIG. 1. The anytime scheduler 602 schedules and executes (and/or otherwise allows use of the scheduled resources by) each of the anytime tasks 604, 606, and 608 based on the resource allocation generated by the policy task 614. In the embodiment shown in FIG. 6, the anytime scheduler 616 also schedules and executes the policy task 614. Because the policy task 614 dynamically adapts the percentage of each scheduled resource that is allocated to each of the anytime tasks 604, 606, and 608, the scheduled resources can be used by the tasks 604, 606, and 608 in a more efficient manner and/or in a manner that allows the system 600 to adjust more effectively to the particular environment in which the aircraft is operated. For example, when the aircraft is near a threat, the policy task 614 is able to allocate additional scheduled resources to the threat tracker task 604 and the route optimization task 608 so that the system 600 is able to evade the threat.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method of scheduling a set of anytime tasks, comprising:
assigning a percentage of at least one resource to each of the set of anytime tasks;
allowing each of the set of anytime tasks to use the at least one resource in accordance with the respective assigned fraction; and
adapting the percentage of the at least one resource assigned to each of the set of anytime tasks.

2. The method of claim 1, wherein the at least one resource comprises at least one of processor time, network bandwidth, energy, and storage.

3. The method of claim 1, wherein at least one anytime task adapts a computational behavior performed thereby in response to the percentage of the at least one resource assigned to that anytime task.

4. The method of claim 1, wherein allowing each of the set of anytime tasks to use the at least one resource in accordance with the respective assigned fraction comprises executing each of the set of anytime tasks, wherein each of the set of anytime tasks uses the at least one resource in accordance with the respective assigned fraction while executing.

5. The method of claim 1, wherein the anytime tasks included in the set of anytime tasks is fixed.

6. The method of claim 1, wherein the anytime tasks included in the set of anytime tasks varies.

7. A method of scheduling a set of anytime tasks for execution on a programmable processor comprising:
executing a policy task on the programmable processor that adapts a percentage of a resource allocated to each of the set of anytime tasks; and
executing each of the set of anytime tasks on the programmable processor in accordance with the percentage of the resource allocated to each of the set of anytime tasks.

8. The method of claim 7, wherein the policy tasks is allocated a percentage of the resource and wherein executing the policy task on the programmable processor comprises executing the policy task on the programmable processor in accordance with the percentage of the resource allocated to the policy task.

9. The method of claim 7, further comprising communicating, from at least one of the anytime tasks to the policy task, information indicative of an amount of the resource that the at least one anytime task wishes to use, wherein the policy task adapts the percentage of the resource allocated to each of the set of anytime task based on the information.

10. The method of claim 7, further comprising communicating, from at least one of the anytime tasks to the policy task, information indicative of the state of the anytime task or of a system, wherein the policy task adapts the percentage of the resource allocated to each of the set of anytime tasks based on the information.

11. The method of claim 7, wherein executing each of the set of anytime tasks comprises:
determining a length of a scheduling period in which each of the set of anytime tasks are to execute; and
determining an amount of the scheduling period that each of the set of anytime tasks are to execute during the scheduling period based the percentage of the resource allocated to each of the set of anytime tasks.

12. The method of claim 11, wherein executing each of the set of anytime tasks further comprises executing each of the set of anytime tasks for the respective amount of the scheduling period.

13. The method of claim 12, wherein executing each of the set of anytime tasks for the respective amount of the scheduling period comprises:
for each of the set of anytime tasks:
setting at timer for a particular anytime task;
causing the particular anytime task to start executing; and
when the amount of the scheduling period for the particular anytime task has elapsed, stopping the execution of the particular anytime task.

14. The method of claim 13, wherein executing each of the set of anytime tasks for the respective amount of the scheduling period comprises:
when each of the set of anytime tasks has executed, if any of the scheduling period remains, causing at least one anytime tasks to execute for at least a portion of the remaining scheduling period.

15. The method of claim 14, wherein the at least one anytime tasks executed for the at least a portion of the remaining scheduling period is selected based on information generated by the policy task.

16. The method of claim 13, wherein executing each of the set of anytime tasks for the respective amount of the scheduling period comprises:
for each of the set of anytime tasks:
when the amount of the scheduling period for the particular anytime task has elapsed, allowing the particular anytime task to continue executing until the amount of time that the particular anytime task executes on the processor equals the amount of the scheduling period for the particular anytime task.

17. The method of claim 11, wherein executing each of the set of anytime tasks comprises:
determining an order in which each of the set of anytime tasks are to execute during the scheduling period; and
executing each of the set of anytime tasks in the order.

18. The method of claim 7, wherein the resource comprises at least one of processor time, network bandwidth, energy, and storage.

19. The method of claim 7, wherein at least one anytime task adapts a computational behavior performed thereby in response to the percentage of the resource allocated to that anytime task.

20. Software comprising a plurality of instructions embodied on a processor-accessible medium, wherein the instructions, when executed by at least one programmable processor, cause the programmable processor to:
execute a policy task that adapts a percentage of a resource allocated to each of a set of anytime tasks; and
execute an anytime scheduler that schedules the execution of a set of anytime tasks in accordance with the percentage of the resource allocated to each of the set of anytime tasks.

21. The software of claim 20, further comprising application software that comprises the policy task and the set of anytime tasks.

22. The software of claim 21, further comprising system software that comprises the anytime scheduler.

23. The software of claim 20, wherein the software comprises the policy task, the set of anytime tasks, and the anytime scheduler.

24. The software of claim 20, wherein the policy task adapts the percentage of the resource allocated to each of the set of anytime tasks by monitoring a discrete state variable and selecting a predetermined set of resource allocations based on the discrete state variable.

25. The software of claim 20, wherein the policy tasks adapts the percentage of the resource allocated to each of the set of anytime tasks using a feedback control law.

26. The software of claim 20, wherein the policy task is included in the set of anytime tasks.

27. The software of claim 20, wherein the resource comprises at least one of processor time, network bandwidth, energy, and storage.

28. The software of claim 20, wherein at least one anytime task adapts a computational behavior performed thereby in response to the percentage of the resource allocated to that anytime task.

29. A system comprising:
a programmable processor; and
software embodied on a medium accessible by the programmable processor, wherein the software comprises program instructions operable to cause the programmable processor to:
execute a policy task that adapts a percentage of a resource allocated to each of a set of anytime tasks; and
execute an anytime scheduler that schedules the execution of a set of anytime tasks in accordance with the percentage of the resource allocated to each of the set of anytime tasks.

30. The system of claim 29, further comprising a sensor that supplies information to at least one of the set of anytime tasks.

31. The system of claim 29, wherein the software further comprises a second scheduler that schedules the execution of the anytime scheduler.

32. The system of claim 31, wherein the second scheduler is a real-time scheduler.

33. The system of claim 29, wherein the anytime scheduler, for each of the set of anytime tasks, starts execution of a particular anytime task and thereafter stops the execution of the particular anytime task in accordance with the respective percentage of the resource allocated to the particular anytime task.

34. The system of claim 33, wherein each of the set of anytime task comprises a thread and wherein the anytime scheduler stops and stops the execution of each of the set of anytime task by explicitly restarting and thereafter explicitly suspending execution of the respective thread.

35. The system of claim 33, wherein each of the set of anytime task comprises a thread and wherein the anytime scheduler stops and stops the execution of each of the set of anytime tasks by adjusting the priority of each of the set of anytime tasks.

36. The system of claim 29, wherein at least one anytime task adapts a computational behavior performed thereby in response to the percentage of the resource allocated to that anytime task.

37. An apparatus comprising:
means for executing a policy task on a programmable processor, wherein the policy task adapts a percentage of a resource allocated to each of a set of anytime tasks; and
means for executing each of the set of anytime tasks on the programmable processor in accordance with the percentage of the resource allocated to each of the set of anytime tasks.
